(19) United States
(12) Patent Application Publication
(10) Pub. No.: US 2015/0338625 A1
(43) Pub. Date: Nov. 26, 2015

(54) MICROSCOPE

(71) Applicant: Leica Microsystems CMS GmbH, Wetzlar (DE)

(72) Inventors: Frank SIECKMANN, Bochum (DE); Stefan HUBER, Schoenau (DE)

(21) Appl. No.: 14/410,263

(22) PCT Filed: Jun. 20, 2013
(86) PCT No.: PCT/EP2013/062925

§ 371 Date: Dec. 22, 2014

(30) Foreign Application Priority Data
Jun. 22, 2012 (DE) 10 2012 105 484.3

(51) Int. Cl. G02B 21/00

(52) U.S. Cl. CPC G02B 21/008

(57) ABSTRACT

A microscope for investigating a microscopic sample is disclosed, the microscope comprising a receiving apparatus that furnishes primary signals which contain at least one information item regarding at least one property of the sample, and the microscope comprising an output apparatus that generates, from the primary signals, secondary signals perceptible by the user. Provision is made that the output apparatus furnishes secondary signals perceptible auditorily and/or perceptible olfactorily and/or perceptible gustatorily and/or perceptible tactilely and/or perceptible by thermoreception; and/or that the microscope comprises a feedback apparatus with which the user can control the receiving apparatus in real time during the sensing of information regarding at least one property of the sample.

### RELATED APPLICATIONS

This Application is a U.S. National Stage Under 35 USC 371 of International Application PCT/EP2013/062925, filed on Jun. 20, 2013, which in turn claims priority to German Patent Applications DE 10 2012 105 484.3, filed Jun. 22, 2012, both of which are incorporated herein by reference in their entirety.

### FIELD OF THE INVENTION

The invention relates to a microscope for investigating a microscopic sample, the microscope comprising a receiving apparatus that furnishes primary signals which contain at least one information item regarding at least one property of the sample, and the microscope comprising an output apparatus that generates, from the primary signals, secondary signals perceptible by the user.

### BACKGROUND OF THE INVENTION

DE 101 49 357 A1 discloses a method and an apparatus for optical measurement of a surface profile of an object. In the method, a series of images of the object in various planes in the Z direction of a coordinate system (X, Y, Z) are acquired with an image acquisition apparatus. The image contents of all n images of the image stack that has been generated are compared with one another at each (X, Y) coordinate point in the Z direction in order to identify a plane therefrom in accordance with predetermined criteria, and to associate its plane number with that coordinate point and store it in a mask image. The mask image contains all the three-dimensional information about the object surface. It can be processed using two-dimensional image processing procedures. The three-dimensional information can be quickly and easily retrieved from the mask image. The surface profile can be reconstructed and can be depicted three-dimensionally.

DE 102 37 470 A1 provides a device for depicted a three-dimensional object as an object image, which device contains an imaging system, in particular a microscope, for imaging the object, and a computer. Actuators serve for rapid, targeted modification of the position of the object in an X, Y, and Z direction. An image stack of individual images in various focal planes of the object is acquired using an image acquisition device. A control device controls the hardware of the imaging system, and an analysis device generates a three-dimensional vertical relief image and a texture from the image stack. A control device combines the three-dimensional vertical relief image with the texture.

WO 03/023482 provides a piezoactuator for adjusting the spacing of the objective from the object in an apparatus for generating a three-dimensional image of an object using an objective and a specimen stage to image the object. An image acquisition apparatus records a series of individual images of the object in various planes. A multifocus image is then generated from this series of individual images.

All these apparatuses for investigating microscopically small objects have in common the fact that the information with regard to the properties of the sample to be investigated is merely displayed visually to the user; and that very limited influence by the user, if any, is possible during the investigation.

### SUMMARY OF THE INVENTION

The object of the present invention is to describe a microscope that works more efficiently in terms of information acquisition and/or information transfer to the user, and that in particular allows information with regard to the sample being investigated to be furnished to the user efficiently and, if necessary, with a greater information content per unit time.

The object is achieved by a microscope which is characterized in that

a. the output apparatus furnishes secondary signals perceptible auditorily and/or perceptible olfactorily and/or perceptible gustatorily and/or perceptible tactilely and/or perceptible by thermoreception; and/or

b. the microscope comprises a feedback apparatus with which the user can control the receiving apparatus in real time during the sensing of information regarding at least one property of the sample.

What has been recognized according to the present invention is, inter alia, that the information content for the user can be substantially increased by adapting the output, preferably in real time, to the perception properties of the observer. In particular, a larger perceptible information quantity regarding the object to be scanned or depicted can be transferred to user by assisting his or her natural sensory information processing of multi-dimensional objects. This can be accomplished, for example, by providing apparatuses that enable the user to perceive additional information by feel, taste, smell, or hearing.

It has moreover been recognized that users can clarify the questions that they have regarding a specific sample much more quickly and efficiently if they have the ability to control the receiving apparatus in real time during the sensing of information regarding at least one property of the sample. As a result, the overall investigation process can be limited to obtaining the essential information, so that investigation can proceed more quickly but also more efficiently.

In a particular embodiment, provision is made that a manipulation of the primary signals is causable with the feedback apparatus. Provision can be made in particular that a manipulation of the primary signals which contains at least one information reduction, in particular by data reduction, is causable with the feedback apparatus; and/or that a manipulation of the primary signals which contains an information reduction, in particular a data reduction, to exclusively the information, in particular data, that are necessary specifically for generating the secondary signals for a currently desired type and/or form of output by the output apparatus, is causable with the feedback apparatus. This embodiment has the particular advantage that a sample can be investigated particularly quickly and efficiently, in particular because a limitation to obtaining the essential information is enabled.

In an advantageous embodiment, the receiving apparatus comprises at least one actuator that is controllable by means of the feedback apparatus. The actuator can be embodied and arranged, for example, to modify the Z position upon scanning of the sample, and/or to modify the X, Y position upon scanning of the sample, and/or to inject a substance (e.g. a drug to influence a cell) and/or to start a further scanning process and/or to initiate an (in particular, three-dimensional) bleaching process.

The scanning process can be influenced to a greater extent by feedback to the actuators as a function of certain results, which are obtained e.g. both by an analysis of the current image and by manual feedback from the user (for example by a mouse click).

In a particular embodiment, provision is made that the receiving apparatus comprises multiple detection channels; and that by means of the feedback apparatus, a manipulation of the primary signals of a detection channel is causable independently of and/or differently from a manipulation of the primary signals of a different detection channel.

Provision can also be made in particular that the receiving apparatus comprises multiple detection channels; and that first secondary signals are generated from the primary signals of a first detection channel; and that independently thereof, second secondary signals are generated from the primary signals of a second detection channel. Provision can also additionally be made here that the first and second secondary signals differ from one another in terms of the nature of their perceptibility; and/or that the first and second secondary signals are outputted separately from one another.

Alternatively, provision can also be made that combined secondary signals are generated from the primary signals of the first detection channel and from the primary signals of the second detection channel.

In a very particularly advantageous embodiment, provision is made that by means of the feedback apparatus, in particular by way of a manipulation performed thereby of the primary signals and/or by way of a modification performed thereby of the receiving apparatus, a transparency regulation of the depiction of the sample in real time is causable; and/or a rotation of the depiction of the sample in real time is causable; and/or a zoom function, in particular a software zoom function or hardware zoom function, in real time is causable; and/or a modification of the shape and/or nature of the secondary signals in real time is causable; and/or an image analysis in real time is causable; and/or an image manipulation in real time is causable; and/or a mosaic depiction in real time is causable; and/or a strip scan in real time is causable; and/or the addition and/or control of at least one virtual light source in the context of depiction of the sample in real time is causable; and/or the addition and/or control of a cast shadow in the context of depiction of the sample in real time is causable; and/or the addition and/or control of section planes in the context of depiction of the sample in real time is causable; and/or a scan position is modifiable, in particular in real time; and/or a sample manipulation, in particular the injection of a substance, is causable; and/or a further scan process is initiatable and/or controllable; and/or a bleaching of a sample is causable; and/or a direct stimulated emission depletion (STED) real-time depiction is causable and/or controllable; and/or a GSDIM depiction (ground state depletion microscopy followed by individual molecule return) is causable and/or controllable.

STED technology is based on illuminating the lateral edge regions of the illumination focus volume with laser light of a different wavelength, emitted e.g. from a second laser, in order to bring the sample regions excited there by the light of the first laser back into the ground state in stimulated fashion. Only the light spontaneously emitted from the regions not illuminated by the second laser is then detected, so that overall an improvement in resolution is achieved.

GSDIM technology is based on emptying the ground state of the fluorescent molecules by strong irradiation so that in the time that follows (several seconds to minutes), individual light flashes illuminate only at isolated locations. The individual light flashes are sensed in terms of their spatial distribution. A statistical evaluation then takes place, for example based on frequency center points. It is also possible to illuminate the sample so weakly that only isolated molecules are excited. A further method for achieving the same effect is to switch the molecules, i.e. not simply to modify an excitation state but in fact to modify the molecules so that in the modified state they can emit light.

A strip scan can contain, for example, illumination of a sample with a flat strip of light that can be generated, for example, with the aid of a cylindrical optic. Alternatively, it is also possible to generate a light strip by weaving an inherently round light ray bundle back and forth, for example with a galvanometer mirror, so quickly that the effect is the same as in the case of a light strip generated by a cylindrical optic.

Provision can also be made that by means of the feedback apparatus a three-dimensional or four-dimensional display or stereo display is manipulatable; and/or that a stereo monitor and/or a set of shutter glasses associated with a three-dimensional monitor is controllable.

Provision can also advantageously be made that by means of the feedback apparatus a superimposition of additional information onto a display or onto a projection surface, which e.g. can also be a user's hand, is controlled.

In a particularly advantageous embodiment, provision is made that a sample manipulation, in particular the injection of a substance and/or an in vitro fertilization or a sample alignment, is causable, in which context the microscope gives the user reports, perceptible auditorily and/or perceptible olfactorily and/or perceptible gustatorily and/or perceptible tactilely and/or perceptible by thermoreception, with regard to the manipulations performed by him or her. For example, by means of a force feedback, in particular in connection with a real-time transmission of secondary signals with regard to the object by the output apparatus, an interaction can occur with the microscopically small object, in which interaction the human senses of touch and vision are addressed simultaneously in such a way that precise microscopic object manipulation can occur.

In a particular embodiment, provision is made that the microscope ascertains from the primary signals, in particular by image analysis, the intersection point of an object in the sample with a previously defined envelope, for example with a scan cube, and calculates therefrom the position for the next envelope, so as thereby to sense the entire object by successive juxtaposition of multiple envelopes, the successive juxtaposition being, in real time, displayed to the user and/or transmitted to the user by way of secondary signals perceptible auditorily and/or perceptible olfactorily and/or perceptible gustatorily and/or perceptible tactilely and/or perceptible by thermoreception. Sensing of the contents of the envelope can be accomplished, for example, by scanning with a scanning microscope. Provision can be made in particular that after sensing of the contents of an envelope, the sample stage is displaced into the calculated position for sensing the contents of the next envelope.

The microscope can be embodied in particular as a scanning microscope, in particular as a confocal scanning microscope. Provision can be made in particular that the microscope is equipped with at least one graphics processing unit, in particular for image calculation and/or for scanning a sample.

Be it noted that for purposes of this Application, “real time” is also to be understood to mean that regardless of a time factor or a delay, the state of the microscope is known at each point in time and is under control, in particular can be influenced, at each point in time.

Further objectives, advantages, features, and possible applications of the present invention are evident from the description below of an exemplifying embodiment with reference to the drawings. All features that are described and/or graphically depicted constitute, individually or in any useful combination, the subject matter of the present invention, independently of their grouping in the claims or their internal references.

### DETAILED DESCRIPTION OF THE PREFERRED EMBODIMENTS

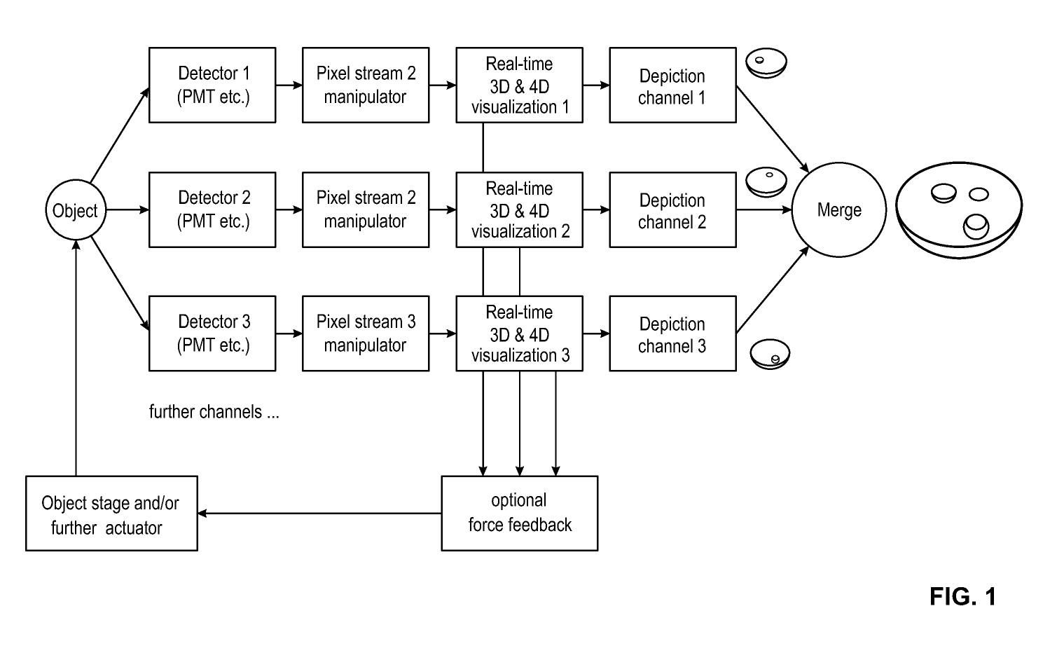

FIG. 1 is the basic execution diagram of an exemplifying embodiment in which the receiving apparatus comprises multiple detection channels, and in which first secondary signals are generated from the primary signals of a first detection channel and, independently thereof, second secondary signals are generated from the primary signals of a second detection channel, and are transmitted to the user in a manner that is perceptible visually and/or auditorily and/or olfactorily and/or gustatorily and/or tactilely and/or by thermoreception.

In this exemplifying embodiment, provision can be made that the primary signals of each channel are initially treated separately. The primary signals of each channel pass through one or more manipulators. These manipulators can manipulate the signal current at a point operator level (e.g. modify brightness). The visualizer module provides storage (buffering) of the individual pixels in a three-dimensional or four-dimensional matrix. This visualization matrix serves as an instantaneous state (snapshot) of the respective channel. In a further display module, the channel is displayed in a manner that is fully manipulatable by the user in real time, or is transmitted to the user in a manner that is perceptible auditorily and/or olfactorily and/or gustatorily and/or tactilely and/or by thermoreception.

Optionally, all or some channels can be displayed together (merge). This three-dimensional or four-dimensional display is also fully manipulatable by the user at the time of scanning, i.e. he or she can rotate, etc. the three-dimensional or four-dimensional object on the monitor during the actual scan.

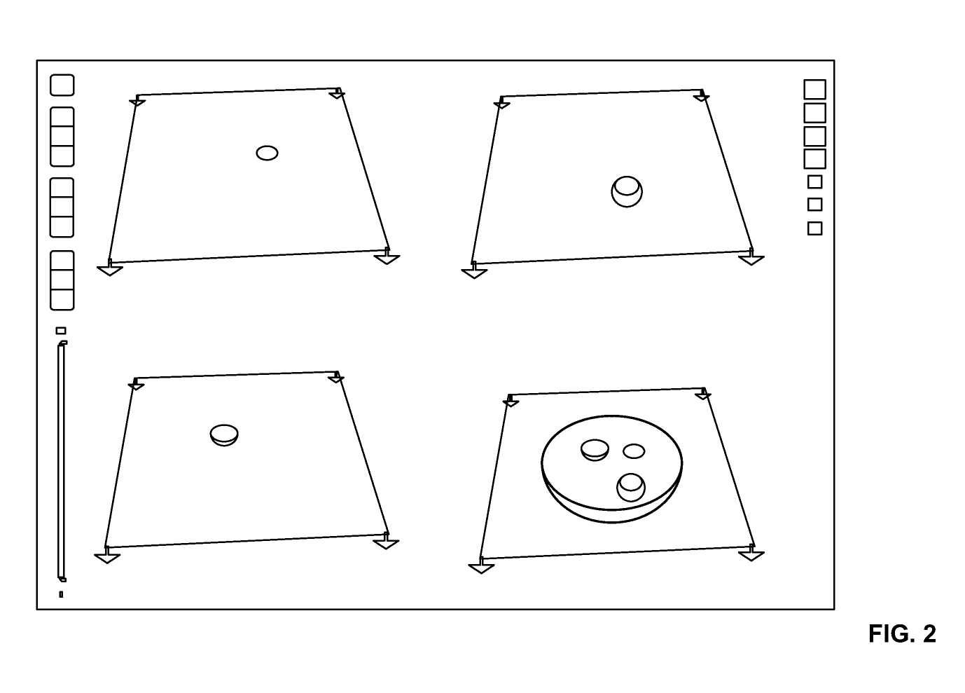

It is possible for both the information of each individual channel, and additionally a combination of the information of multiple, in particular all channels, to be simultaneously displayed visually and/or transmitted to the user in a manner that is perceptible auditorily and/or olfactorily and/or gustatorily and/or tactilely and/or by thermoreception, which is indicated by way of example in FIG. 2 for a visual depiction.

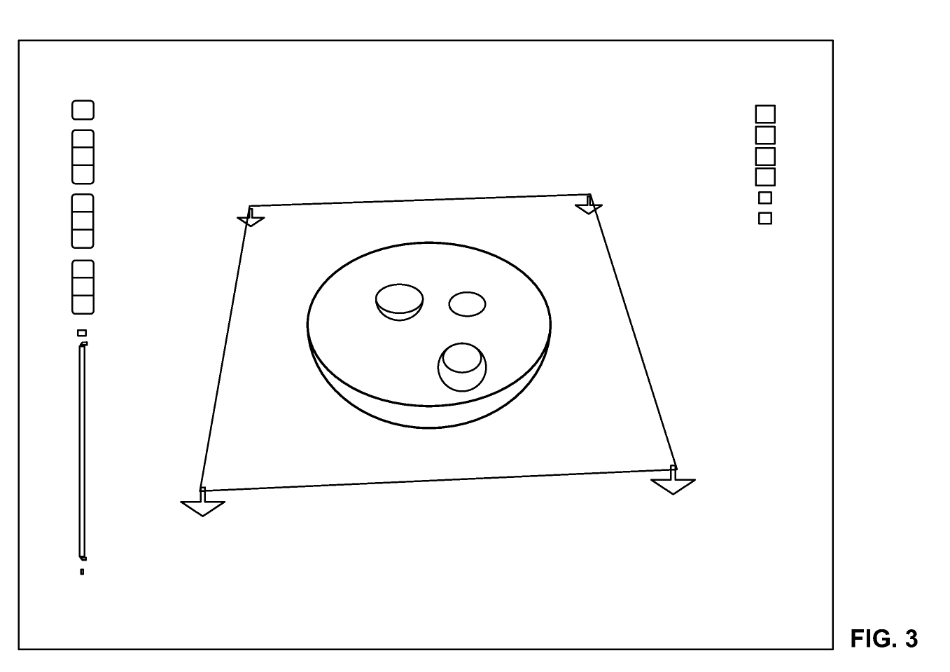

Alternatively, of course, it is also possible for exclusively only a summary of the information of multiple, in particular all channels to be displayed visually and/or transmitted to the user in a manner that is perceptible auditorily and/or olfactorily and/or gustatorily and/or tactilely and/or by thermoreception, which is indicated by way of example in FIG. 3 for a visual depiction.

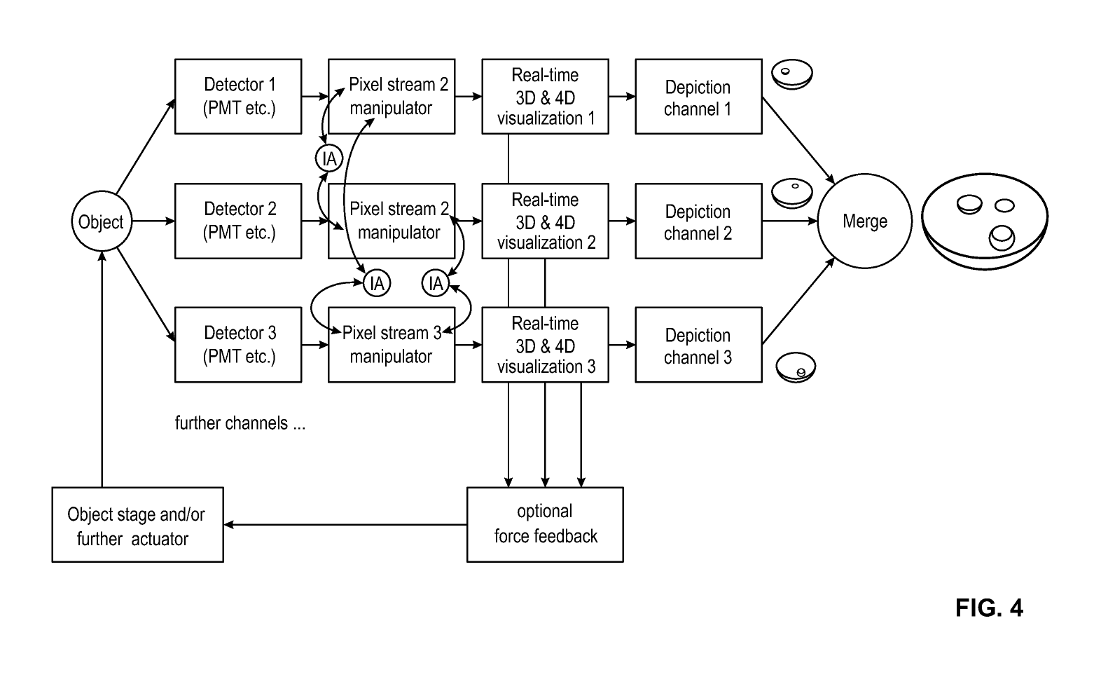

FIG. 4 depicts the basic execution diagram of an exemplifying embodiment in which processing of the individual signals by image analysis (IA) takes place in consideration of the signals of adjacent channels, for example in order to decrease noise.

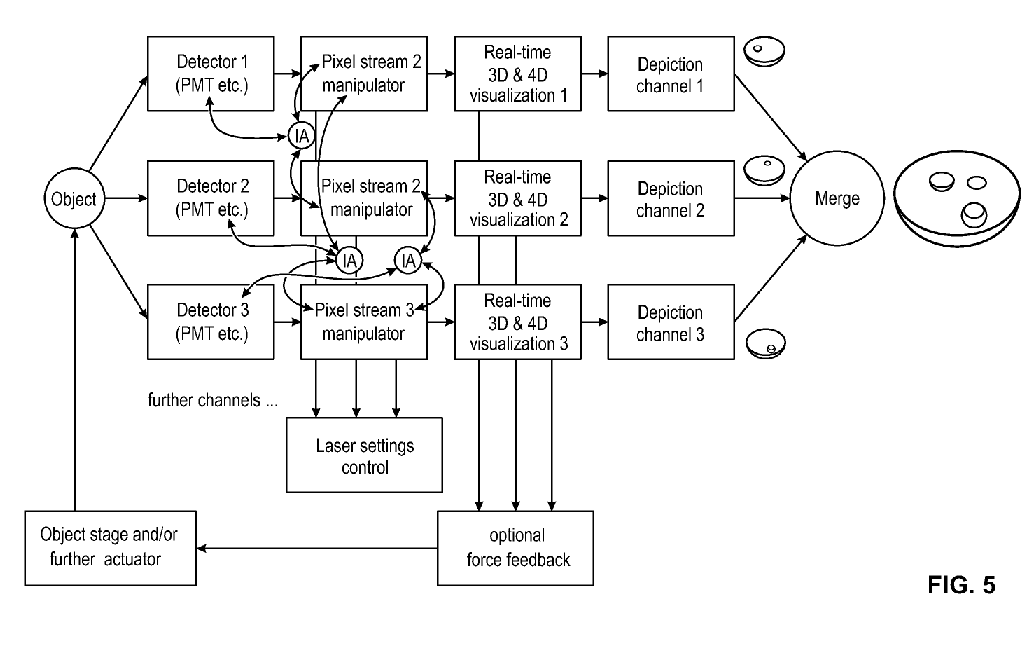

In another exemplifying embodiment, the analysis modules IA are used to feed back settings, as a function of the analysis, to the detector unit (gain) or/and to the laser (intensity), thereby achieving a real-time optimization of the pixel stream for all channels; this is depicted schematically in FIG. 5.

If a channel is, for example, too dark, the laser intensity or the gain can then be automatically optimized. If noise is excessive, an optimizing intervention can also be effected.

The scanning process can be influenced to a larger degree by feedback to the actuators as a function of certain results that are obtained both by analysis of the current image and by manual feedback from the user (e.g. a mouse click). For example, portions of the hardware can be influenced, for example the Z position of the scan can be modified and/or the X, Y position can be modified and/or a substance (e.g. a drug to influence a cell) can be injected and/or a different scanning process can be initiated and/or an (in particular, three-dimensional) bleaching process can be initiated.

In particular, the image analysis can also be accomplished externally and can be fed back via computer-aided microscope (CAM) in order to influence the scanning process.

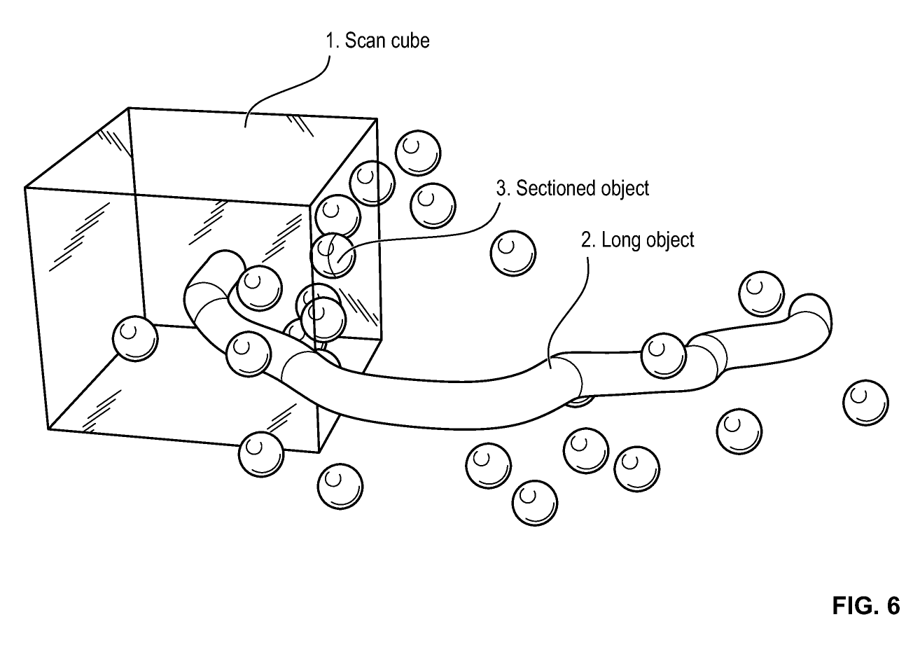

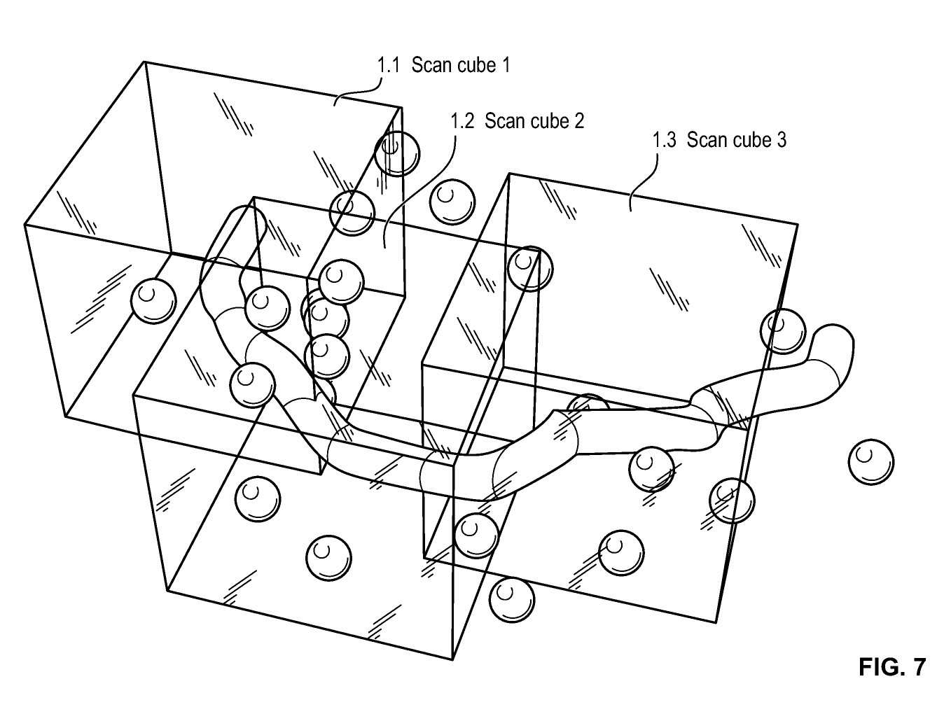

FIG. 6 illustrates the obtaining of information using an exemplifying embodiment of a scanning microscope according to the present invention with regard to an object inside the sample which is bigger than an envelope, in particular bigger than an envelope that is determined by the maximum possible scan volume.

Provision is made here that the microscope ascertains from the primary signals, in particular by image analysis, the intersection point of an object in the sample with a previously defined envelope, for example with a scan cube, and calculates therefrom the position for the next envelope, so as to sense the entire object by successive juxtaposition of multiple envelopes, the successive juxtaposition being, in real time, displayed to the user and/or transmitted to the user by way of secondary signals that are perceptible auditorily and/or perceptible olfactorily and/or perceptible gustatorily and/or perceptible tactilely and/or perceptible by thermoreception.

The result is a juxtaposition that accurately follows the course of the structure to be investigated.

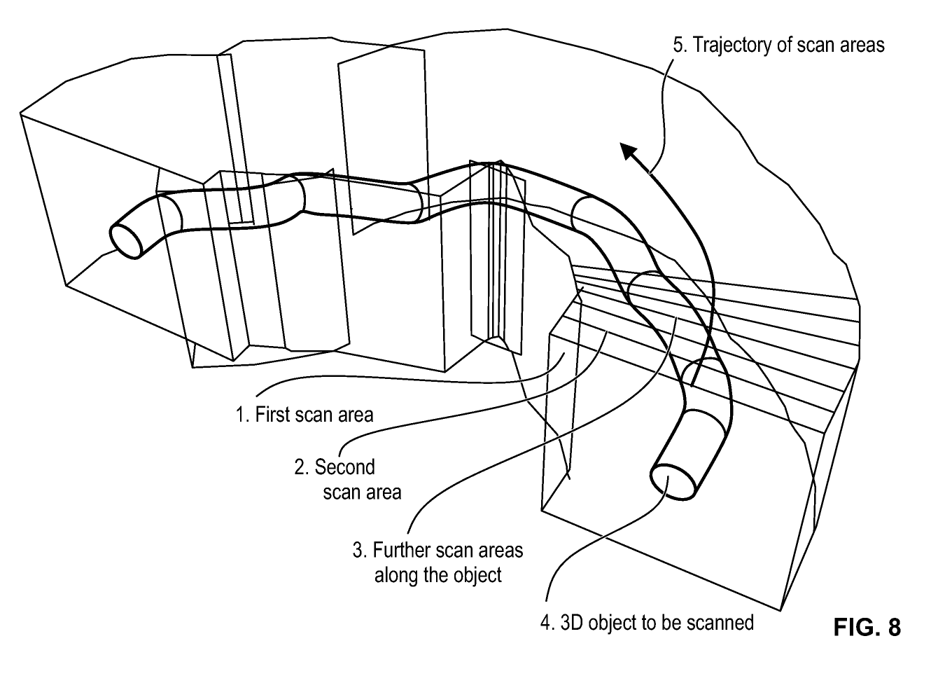

FIG. 8 shows a particular exemplifying embodiment in which, in addition to tracking of the course of the object to be investigated within the sample, a rotation of the scan axis takes place.

For example, by the fact that firstly two XZ scans have been carried out at adjacent X, Y positions on a sample stage (1, 2 in the image), it is possible to determine by image analysis, via a center point determination of the object (4) to be tracked, a directional trend (5) of the object course. After the scan of the first scan area (1), the beam axis and the microscope stage, as well as the Z position, are then moved appropriately in such a way that the system follows the object to be scanned. A further XZ scan at the new position again enables an adaptation of the scanning path, and so forth. The upshot is therefore that the scanning system tracks the three-dimensional object being scanned over a greater distance, and allows the scanning even of three-dimensional objects that extend over a very large region.

1. A microscope for investigating a microscopic sample, the microscope comprising a receiving apparatus that furnishes primary signals which contain at least one information item regarding at least one property of the sample, and an output apparatus that generates, from the primary signals, secondary signals perceptible by a user, wherein:
a. the output apparatus furnishes secondary signals perceptible in at least one of the following: auditorily and perceptible olfactorily and perceptible gustatorily and perceptible tactilely and perceptible by thermoreception; or
b. the microscope comprises a feedback apparatus with which the user can control the receiving apparatus in real time during the sensing of information regarding at least one property of the sample; or
the output apparatus furnishes secondary signals perceptible in at least one of the following: auditorily and perceptible olfactorily and perceptible gustatorily and perceptible tactilely and perceptible by thermoreception; and the microscope comprises a feedback apparatus with which the user can control the receiving apparatus in real time during the sensing of information regarding at least one property of the sample.

2. The microscope according to claim 1, wherein
a. a manipulation of the primary signals is causable with the feedback apparatus; or
b. a manipulation of the primary signals which contains at least one information reduction or data reduction; is causable with the feedback apparatus; or
c. a manipulation of the primary signals which contains an information reduction or, a data reduction, to exclusively the information or particular data, that are necessary specifically for generating the secondary signals for a currently desired type or form of output by the output apparatus, is causable with the feedback apparatus.

3. The microscope according to claim 1, wherein the receiving apparatus comprises at least one actuator that is controllable by means of the feedback apparatus.

4. The microscope according to claim 1, wherein the receiving apparatus comprises multiple detection channels; and by means of the feedback apparatus, a manipulation of the primary signals of a detection channel is causable independently of and/or differently from a manipulation of the primary signals of a different detection channel.

5. The microscope according to claim 1, wherein the receiving apparatus comprises multiple detection channels; and first secondary signals are generated from the primary signals of a first detection channel; and independently thereof, second secondary signals are generated from the primary signals of a second detection channel.

6. The microscope according to claim 5, wherein
a. the first and second secondary signals differ from one another in terms of the nature of their perceptibility; or
b. the first and second secondary signals are outputted separately from one another.

7. The microscope according to claim 5, wherein combined secondary signals are generated from the primary signals of the first detection channel and from the primary signals of the second detection channel.

8. The microscope according to claim 1, wherein a by means of the feedback apparatus or by way of a manipulation performed thereby of the primary signals or by way of a modification performed thereby of the receiving apparatus, at least one of the following is causable:
a. a transparency regulation of the depiction of the sample in real time; and
b. a rotation of the depiction of the sample in real time; and/
c. a zoom function or a software zoom function or a hardware zoom function, in real time; and
d. a modification of the shape or nature of the secondary signals in real time; and
e. an image analysis in real time; and
f. an image manipulation in real time; and
g. a mosaic depiction in real time; and
h. a strip scan in real time; and
i. the addition or control of at least one virtual light source in the context of depiction of the sample in real time; and
j. the addition or control of a cast shadow in the context of depiction of the sample in real time; and/or
k. the addition or control of section planes in the context of depiction of the sample in real time: and
l. a sample manipulation or the injection of a substance; and
m. an in-vitro fertilization or a sample alignment; and
n. a bleaching of a sample; and
o. a direct STED real-time depiction: and
p. a GSDIM depiction (ground state depletion microscopy followed by individual molecule return).

9. The microscope according to claims 1, wherein a sample manipulation or the injection of a substance or an in-vitro fertilization or a sample alignment, is causable, in which context the microscope gives the user reports with regard to the manipulations performed by him or her in at least one of the following ways: perceptible auditorily and perceptible olfactorily and perceptible gustatorily and perceptible tactilely and perceptible by thermoreception.

10. The microscope according to claims 1, wherein the microscope ascertains from the primary signals the intersection point of an object in the sample with a previously defined envelope, for example with a scan cube, and calculates therefrom the position for the next envelope, so as thereby to sense the entire object by successive juxtaposition of multiple envelopes, the successive juxtaposition being, in real time, displayed to the user or transmitted to the user by way of secondary signals in at least one of the following ways: perceptible auditorily and/or perceptible olfactorily and perceptible gustatorily and perceptible tactilely and/or perceptible by thermoreception.

11. The microscope according to claim 1, wherein the microscope is embodied as a scanning microscope or as a confocal scanning microscope.

12. The microscope according to claim 1, wherein by means of the feedback apparatus or by way of a manipulation performed thereby of the primary signals or by way of a modification performed thereby of the receiving apparatus, at least one of the following is controllable:
a. a further scan process; and
b. a direct STED real-time depiction; and
c. a GSDIM depiction (ground state depletion microscopy followed by individual molecule return); and
d. a stereo monitor or a set of shutter glasses associated with a three-dimensional monitor; and
e. a superimposition of additional information onto a display or onto a projection surface, which can also be a user's hand.

13. The microscope according to claim 1, wherein by means of the feedback apparatus or by way of a manipulation performed thereby of the primary signals or by way of a modification performed thereby of the receiving apparatus,
a scan position is modifiable or a scan position is modifiable in real time; or
a three-dimensional or four-dimensional display or stereo display is manipulatable; or
a further scan process is initiatable.
